(19) United States
(12) Patent Application Publication
(10) Pub. No.: US 2026/0032411 A1
(43) Pub. Date: Jan. 29, 2026

(54) SYSTEM AND METHOD FOR CHARGING ELECTRIC VEHICLES AT A CHARGE DEPOT UTILIZING SIGNAL STRENGTH DATA

(71) Applicant: Ford Global Technologies, LLC, Dearborn, MI (US)

(72) Inventors: Stuart C. Salter, White Lake, MI (US); Peter J. Nikolajevs, Dearborn, MI (US); Ryan O'Gorman, Beverly Hills, MI (US); Annette Lynn Huebner, Highland, MI (US); Brendan Diamond, Naples, FL (US)

(21) Appl. No.: 18/787,238

(22) Filed: Jul. 29, 2024

(51) Int. Cl. H04W 4/44; B60L 53/30; B60L 53/66; B60L 53/67; B60L 53/68; H04B 17/318; H04W 16/26

(52) U.S. Cl. CPC H04W 4/44; B60L 53/305; B60L 53/66; B60L 53/67; B60L 53/68; H04B 17/318; H04W 16/26

(57) ABSTRACT

A system for charging one or more electric vehicles (EV) at a charge depot includes one or more communication devices and one or more computing devices. The communication devices are configured to define a first wireless communication network (WCN) for the charge depot having a plurality of electric vehicle supply equipment (EVSE). The computing devices are configured to define a connectivity map of an area including the plurality of EVSE using signal strength data from at least one EVSE among the plurality of EVSE, where the connectivity map provides signal strength of the first WCN. The computing devices are further configured to transmit a charge instruction to an EV among the one or more EVs assigning a designated EVSE from among the plurality of EVSE at which the EV is to charge based on the signal strength at the designated EVSE provided by the connectivity map.

### TECHNICAL FIELD

The present disclosure is generally directed towards a system or method for a charge depot having multiple electric vehicle supply equipment to charge electric vehicles.

### BACKGROUND

The statements in this section merely provide background information related to the present disclosure and may not constitute prior art.

Electric vehicles (EVs), such as plug-in hybrid or full EVs, generally use an electric vehicle supply equipment (EVSE) to charge a battery pack of the EV. The EVSE not only includes complex power electronics (e.g., inverters, DC-DC converters) to charge and discharge power, but also has sophisticated programming to control the transfer of power, which may be managed remotely. Accordingly, the EVSE may include communication devices to establish wireless communication with external devices/systems.

### SUMMARY

This section provides a general summary of the disclosure and is not a comprehensive disclosure of its full scope or all of its features.

In one form, the present disclosure is directed to a system for charging one or more electric vehicles (EV) at a charge depot. The system includes one or more communication devices and one or more computing devices. The one or more communication devices are configured to define a first wireless communication network (WCN) for the charge depot having a plurality of electric vehicle supply equipment (EVSE). The one or more computing devices are configured to: define a connectivity map of an area including the plurality of EVSE using signal strength data from at least one EVSE among the plurality of EVSE, the connectivity map providing signal strength of the first WCN; and transmit a charge instruction to an EV among the one or more EVs assigning a designated EVSE from among the plurality of EVSE at which the EV is to charge based on the signal strength at the designated EVSE provided by the connectivity map.

In one form, the present disclosure is directed to a method for controlling charging of one or more electric vehicles (EV) at a charge depot. The method includes generating, a first wireless communication network (WCN) for the charge depot having a plurality of electric vehicle supply equipment (EVSE), defining a connectivity map of an area including the plurality of EVSE using signal strength data from at least one EVSE among the plurality of EVSE, where the connectivity map provides signal strength of the first WCN, and transmitting a charge instruction to an EV among the one or more EVs assigning a designated EVSE from among the plurality of EVSE at which the EV is to charge based on the signal strength at the designated EVSE provided by the connectivity map.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

In order that the disclosure may be well understood, there will now be described various forms thereof, given by way of example, reference being made to the accompanying drawings, in which:

FIG. 1 illustrates a charge depot for charging electric vehicles;

FIG. 2 illustrates a block diagram of a depot control system for the charge depot of FIG. 1;

FIG. 3A illustrates an example of a connectivity to indicate signal strength;

FIG. 3B illustrates another example of a connectivity map using a scoring technique to indicate signal strength;

FIG. 4 illustrates a flowchart of an example connectivity map routine; and

FIG. 5 illustrates a flowchart of an example charge operation control routine.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

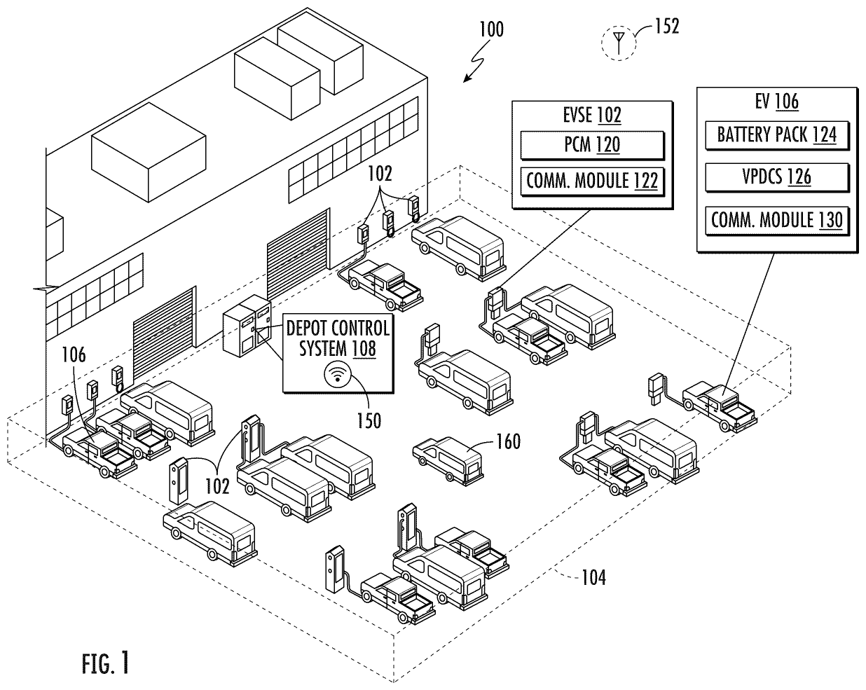

Referring to FIG. 1, a charge depot 100 having a plurality of electric vehicle supplying equipment (EVSE) 102 arranged in a defined area 104 for charging multiple electric vehicles (EV) 106. In some aspects, the charge depot 100 includes a depot control system 108 that is configured to communicate with the EVSE 102 and, in some applications, with the EV 106 using one or more wireless communication networks (WCNs). Based on the strength of the WCN, the depot control system 108 schedules charge operations of the EVs 106 at assigned EVSE 102.

It should be readily understood that the defined area 104 of the charge depot 100 is illustrated as a three-dimensional space having a box like shape for discussion purposes only, and that the defined area 104 that physically defines the charge depot 100 may be recognized using two or more dimensions have different shape and/or size.

In one form, among other modules, the EVSE 102 is configured to include a power control module (PCM) 120 and a communication (Comm.) module 122. The PCM 120 is configured to manage transfer of electrical energy between an external power source (e.g., power grid) and the EV 106. Among other electrical devices, the PCM 120 may include a charge connector for connecting to a charge port of the EV 106, a power inverter, DC-DC converter, and/or power relays. In some aspects, the EVSE 102 communicates with the EV 106 using physical communication ports at the charge connector of the EVSE 102 and the charge port of the EV 106 (e.g., control pilot) to exchange information related to the charge operation, such as, but not limited to, state of charge of the battery pack.

The communication module 122 is configured to communicably couple the EVSE 102 to other devices and/or systems using one or more WCNs supported by one or more wireless communication protocols. In a non-limiting example, the communication module 122 may employ wireless communication protocols such as: Wi-Fi, cellular, BLUETOOTH, and/or ultra-wideband (UWB)), and may include communication devices such as, but not limited to, antenna, transceiver, router, and/or software protocols executed by a processor.

In some aspects, using the communication module 122, the EVSE 102 is configured to exchange messages to provide remote monitoring and/or control of the EVSE 102 to, for example, the depot control system 108, EV 106, a remote server (not shown), a computing device (e.g., smart phone) (not shown) having a software application associated with the EVSE 102. In a non-limiting example, the EVSE 102 provides information related to performance or operation of the EVSE such as, but not limited to: a signal strength of a WCN detected by the module 122; availability of the EVSE 102; a charge status of the EV 106 being charged if applicable; and/or routine diagnostic results. Similarly, the EVSE 102 receives information/requests from external system, such as, but not limited to: an availability inquiry from the depot control system 108; a request to perform a diagnostic check or software update from the depot control system 108 and/or the remote server; instructions to activate or deactivate a charge operation provided by the depot control system 108 and/the computing device; and/or charge status inquiry from the depot control system 108 and/or the computing device.

The EV 106 may be a full-electric vehicle, a plug-in hybrid vehicle, or any other vehicle having a battery pack 124 that can be recharged using the EVSE 102 and controlled via a vehicle power-driver control system (VPDCS) 126. In one form, the VPDCS 126 is configured to estimate battery characteristics such as SOC, power limits, voltage and current of the battery pack 124. In addition, if applicable, the VPDCS 126 control transfer of power during charging or discharging of the battery pack 124.

In some aspects, the EV 106 may have no automation features in which the driver manually controls the EV 106 or may have partial to full-automation features that provide some level of automation employable by the driver. Based on the level of automation, the EV 106 may communicate differently with external devices. In a non-limiting example, an EV 106 having no automation may display messages to the driver using one or more user interfaces in the EV 106 (e.g., audio system or visual system) to inform the driver of next steps of the charge operation (e.g., which EVSE 102 the driver should go to). Alternatively, if the EV 106 is fully automated, the VPDCS 126 may receive travel instructions to a destination (e.g., an assigned EVSE) and autonomously drive to the destination. Even with the fully automated feature, the EV 106 may notify passengers of the travel to the destination using the user interface 108.

With the rise of connectivity, the EV 106 further includes a communication module 130 configured to communicate with external devices/systems using one or more WCN (e.g., BLUETOOTH, WI-FI, UWB, vehicle-to-anything (V2X)). In some aspects, the communication module 130 may also be configured to define a vehicle wireless communication network/hotspot that external devices may join to communicate with other devices/systems. As such, if a cellular network is down or has poor signal strength, the EVSE 102 may join the vehicle hotspot to communicate to other EVSE 102, the EV 106, and/or to the depot control system 108. In one form, the communication module 130 may include a router, a modem, an antenna, an input-output interface, a universal serial bus (USB) port, and/or other suitable devices for wireless and wired communication.

With the communication module 130, the EV 106 communicates with other EVs, the depot control system 108, and/or the EVSE 102. In a non-limiting example, using V2X, the EV 106 communicates with the depot control system 108 to provide vehicle information regarding the EV 106 (e.g., vehicle identification, antenna type, and/or state of charge (SOC)) and request instructions for where to charge. In response to the request and the vehicle information, the depot control system 108 selects an EVSE 102 and provides instructions to the EV 106 regarding the selected charge operation.

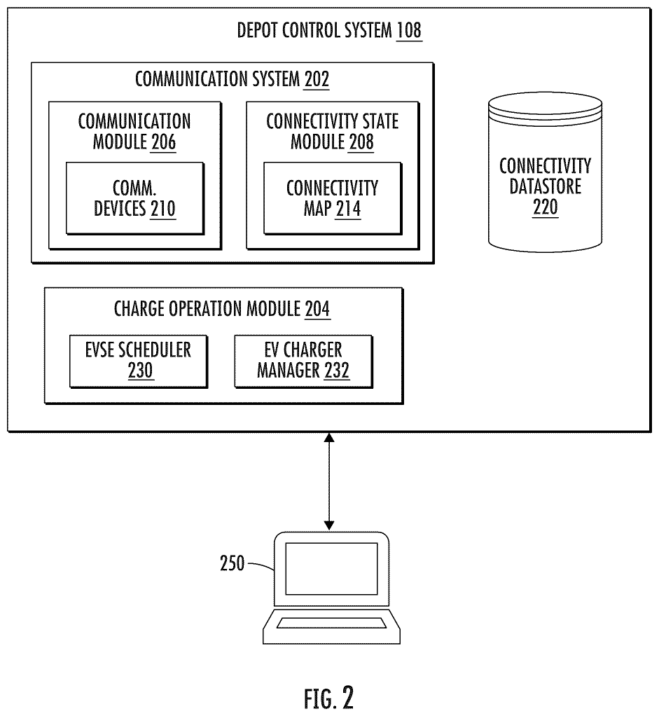

Referring to FIG. 2, the depot control system 108 includes a communication system 200 and a charge operation module 204. The communication system 202 is configured to provide a local WCN 150 (FIG. 1) (e.g., Wi-Fi network) for devices located within a reception zone of the local WCN 150 such as the EVSE 102 and/or EVs 106. The communication system 202 is further configured to monitor a connectivity state of the charge depot with respect to the local wireless network and, if applicable, a cellular network 152 (FIG. 1) that may use a different communication protocol than the local WCN 150. In the following, the local WCN 150 and the cellular network 152 may collectively be referred to as WCN 150, 152.

In one form, the communication system 202 includes a communication module 206 and a connectivity state module 208 for monitoring the connectivity of the WCN 150, 152. The communication module 206 includes one or more communication devices 210 for forming the local wireless network 150 and for joining and communicating with the cellular network 152. In a non-limiting example, the communication devices 210 includes, but not limited to: modem, router, antenna system, wireless repeater, and/or processor configured to communicative via the protocols used for the wireless networks 150, 152. In the following, the communication module 210 may be referenced to as the depot communication module 210 to distinguish from the EVSE communication module 122 and the EV communication module 130.

The connectivity state module 208 is configured to define a connectivity map 214 of the area 104 using signal strength data from, for example, one or more of EVSE 102, the depot communication module 206, and/or EV 106. Using various techniques (e.g., series of algorithms or a computer model), the connectivity state module 208 is configured to transpose the measured signal strength to a map of the charge depot 100 and, in some aspects, estimate an inferred signal strength for various regions not having a measured signal strength using, at least, the measured signal strength data from at least one EVSE 102. Accordingly, the connectivity map 214 defines signal strength at one or more regions not having an EVSE 102 and/or not providing measured signal strength data. In addition to the measured signal strength data, the connectivity state module 208 may use other data for estimating the inferred signal strength such as, but not limited to, the distance between the two measured signal strengths, operation characteristic of an antenna that detects the signal (e.g., characteristics of the antenna in the EVSE 102 or the EV 106), and/or weather conditions.

In some forms, the connectivity map 214 provides the signal strength of one or more of the wireless networks 150, 152, and other information, such as but not limited to: location of each EVSE 102; position of communication devices provided in the area (e.g., location routers, modems, and/or signal repeaters); indicates the signal strength at various locations of the area 104, and/or actual measured signal strength at respective locations.

The following provides examples of different techniques for identifying the signal strength in the connectivity map 214, which may be implemented separately or in combination of one another. In addition, while specific examples are provided, the connectivity map 214 may be realized in other suitable ways to identify the area 104 and signal strength at least at the EVSE 102. For example, in lieu of a schematic of the area 104, the connectivity map may be provided as a look-up table providing signal strength at least at the EVSE 102.

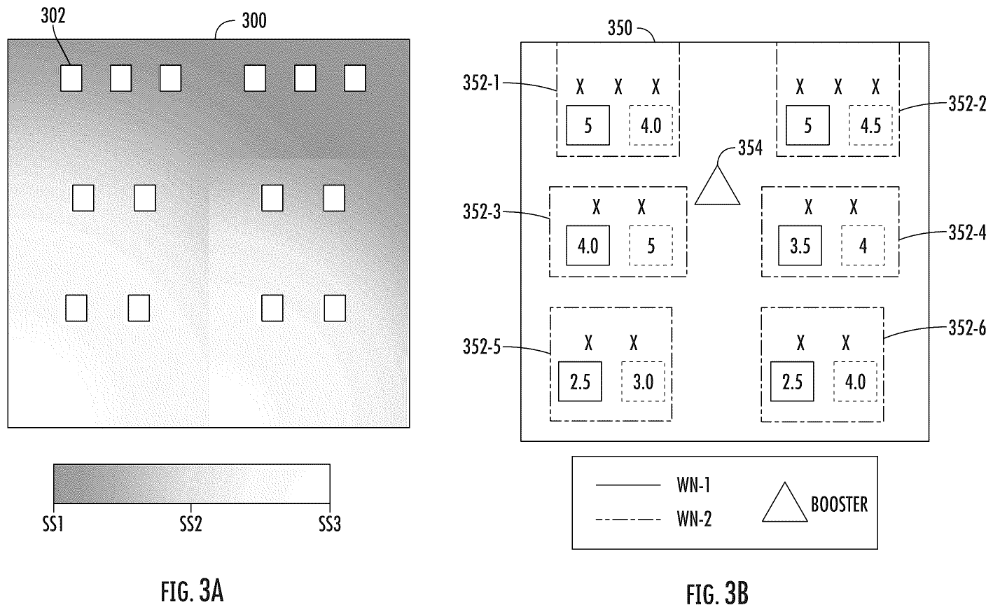

Referring to FIG. 3A, a connectivity map 300 identifies the location of each EVSE using a marker 302 (e.g., rectangular box) and presents the signal strength using a heat map in which color is employed to indicate the signal strength. Here, the signal strength (SS) is categorized based on three signal strength values (SS1, SS2, SS3, where SS1>SS2>SS3). In a non-limiting example, SS1 indicates a “strong” signal strength (e.g., −50 to −85 dBm), SS2 indicates an average signal strength (e.g., −85 to −99 dBm), and SS3 indicates a “poor” signal strength (e.g., −100 to −120 dBm). In one form, a heat map is provided for each WCN 150, 152.

Referring to FIG. 3B, a connectivity map 350 includes multiple zones 352-1 to 352-6 (collectively zones 352), where the zones 352 include at least one EVSE 102, which is identified by “X.” Each zone 352 is assigned a score between 1-5 to indicate the signal strength, where a score greater than or equal to 4 indicates a “strong” signal strength (e.g., −50 to −85 dBm), a score greater than or equal to 2.5 and less than 4 indicates an “average” signal strength (e.g., −85 to −99 dBm) that is less than SSTH-1 but greater than SSTH-2, and a score equal to and greater than 1 but less than 2.5 indicates a “poor” signal strength (e.g., −100 to −120 dBm). In FIG. 3B, each WCN 150, 152 may be represented by providing a separate score for each WCN 150, 152 for each zone 352. In addition, FIG. 3B illustrates the location of one or more devices 210 using a selected indicia 354 (e.g., a triangle for a booster).

With continue reference to FIG. 2, in some variations, the connectivity state module 208 may use historical information to estimate the signal strength. In a non-limiting example, the depot control system 108 includes a connectivity datastore 220 that stores historical data associated with previous connectivity maps 214, such as signal strength data and supplemental data. The supplemental data relates to the signal strength data and may include measured signal strength data used to define the connectivity map 214; time stamp; weather information associated with the measured signal strength data. location of the source of the measured strength data, among other information that may affect estimation of signal strength.

Using machine learning models, the connectivity state module 208 may be configured to detect relationship between signal strength and various factors, which may be used to estimate signal strength using current and historical data. In a non-limiting example, if the weather is clear with no storms, the signal strength on those days may be higher than the days having thunderstorms or snowstorms. Using, for example I2X, the connectivity state module 208 may obtain weather forecast for a selected day from a source broadcasting such data to estimate the signal strength.

Using the connectivity map 214, the connectivity state module 208 is configured to detect a region of the area 104 having a signal strength less than or equal to a signal strength (SS) threshold indicating a low signal region. If there is a low signal region, the connectivity state module 208 may enhance or boost the signal by adding a repeater. For example, the charge depot 100 may have a mobile signal repeater 160 (FIG. 1) having a repeater to boost signals of the local WCN 150, and the connectivity state module 208 is configured to instruct the mobile signal repeater 160 to the low signal region to increase the signal strength. The mobile signal repeater 160 may be vehicle (EV or non-EV) that is manually operated to the low signal region. In another example, the mobile signal repeater 160 may be an automated device (e.g., autonomous multi-wheel vehicle, a robot, or an aerial object) that may receive data indicative of a location of the low signal region and then autonomously travels to the region.

In some variations, the EVSE communication module 122 may operate as repeaters to boost signal of the local WCN 150. In a non-limiting example, the EVSE communication module 122 may have an operation setting and/or a software application that generates a hotpot at EVSE 102 that is used as proxy to the local WCN 150. With this setting option, the connectivity state module 208 is configured to transmit a message to a selected EVSE 102 associated with the low signal region instructing the selected EVSE 102 to operate as a repeater.

In one form, the connectivity state module 208 is further configured to provide prioritize available WCN for the area 104. That is, based on the connectivity map 214, if the local WCN 150 provides a signal strength greater than or equal to a selected SS threshold at the EVSE 102, the connectivity state module 208 instructs the EVSE 102 to employ the local WCN 150 over the cellular WCN 152, as the later may require additional charges.

The charge operation module 204 is configured to control and manage charge operations of the EVSE 102 and EVs 106 from tracking availability of the EVSE 102, directing an incoming EV 106 to a designated EVSE 102 for charging, and monitoring charge operation based on data from the EVSE 102. In a non-limiting example, the charge operation module 204 is operable as an EVSE scheduler 230 and an EV charge manager 232.

In one form, the EVSE scheduler 230 is configured to track the operation state of each EVSE 102, which may be provided by the EVSE 102 and/or the EV charge manager 232. In a non-limiting example, the EVSE state can include: “stand-by” indicating the EVSE 102 is ready to charge; “charge in-progress” indicating that the EVSE 102 is charging an EV 106; and “off-line” indicating the EVSE 102 is unavailable for charging due to, for example, maintenance or needs repair.

The EV charge manager 232 is configured to assign the EV 106 to an EVSE 102 based on, at least, the connectivity map 214. That is, the EV charge manager 232 selects a designated EVSE 102 based on the signal strength at the EVSE 102. In a non-limiting example, the EV charge manager 232 determines if the signal strength at the EVSE 102 is equal to or greater than a signal strength threshold, where the threshold is associated with the representation provided in the connectivity map 214 (e.g., color, score, and/or dBm). In some aspects, the signal strength threshold is selected so that the EV 106 is subjected to uninterruptable communication.

In some forms, the EV charge manager 232 may use the connectivity map 214 to estimate an EV inferred signal strength, which is the signal strength as it relates to an antenna of the EV 106. Specifically, an antenna in the EV 106 is likely not the same as an antenna of the EVSE 102 and therefore, the estimated signal strength at the designated EVSE 102 may not be strong enough for the antenna of the EV 106. Using information related to the antenna in the EV 106 (e.g., power, directivity, gain), which may be provided by the EV 106, the EV charge manager 232 is configured to estimate the EV inferred signal strength using various techniques. In a non-limiting, the EV charge manager 232 uses information related to the antenna of at least one EVSE 102 that provided the signal strength data employed to generate the connectivity map 214, and compares the antenna information of the EVSE 102 to that of the antenna of the EV 106 to determine a correlation that is used to estimate the EV inferred signal strength at the designated EVSE 102 based on signal strength provided by the connectivity map 214.

Furthermore, the local Wi-Fi network can provide varying signal strength due to various factors, such as but not limited to, weather conditions, condition of cable/satellite/cellular infrastructure supporting the local Wi-Fi network, other wireless communication networks (e.g., BLUETOOTH and other Wi-Fi hot spots in the area), and/or number of devices on the local Wi-Fi network.

In some aspects, in addition to the signal strength, the EV charge manager 232 may also select the designated EVSE based on the type of charge port employed by the EV 106, and/or a SOC of the EV 106 to estimate the amount of time needed to charge the EV 106 to fully charge. In a non-limiting example, if two EVSE 102 are available and have suitable signal strength, the EV charge manager 232 may select the EVSE 102 that can charge the EV 106 faster.

In a non-limiting example, once entering the charge depot 100, the EV 106 may transmit a message indicative of a charge request received by the EV charge manager 232. The charge request may include information assisting the EV charge manager 232 in selecting the EVSE 102, such as, but not limited to, vehicle identification, the type of charge port provided on the EV 106, SOC, and/or a desired pickup time of the EV 106 by the passenger. Using the information, the EV charge manager 232 selects an EVSE 106 from among the plurality of EVSE 102 that, for example, is available, has suitable signal strength, has a charge connector compatible with the charge port of the EV 106, and/or is able to charge the EV 106 by the desired pickup time. Once selected, the EV charge manager 232 transmits a message to the EV 106 providing information related to the location of the designated or assigned EVSE 102, and may also transmit a message to the assigned EVSE 102 providing information related to the EV 106 (e.g., vehicle identification or SOC) and indicating that the EV 106 will be connecting to the EVSE 102. In response to receiving the location information, the EV 106 travels to the designated EVSE 102 autonomously and/or under the control of a driver.

In some forms, the data control system 108 is accessible to a user via a computing device 250 in communication with the depot control system 108. In a non-limiting example, the user may access current and previous connectivity maps 214 to identify signal strength trends that can be used to determine if additional communication devices, such as signal booster/repeater, should be provided at the depot 100. Analysis of connectivity trends may also be done with assistance of advanced machine learning software.

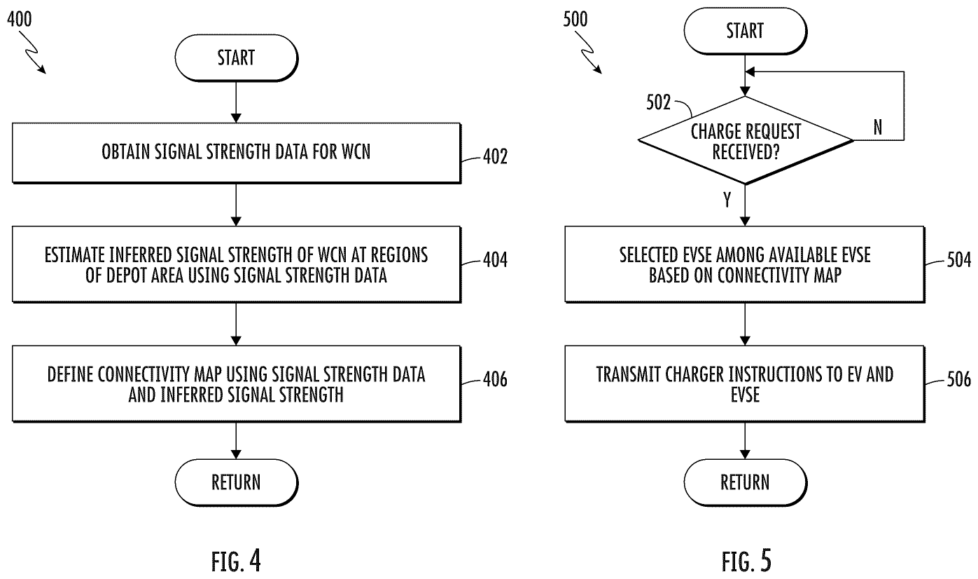

Referring to FIG. 4, an example connectivity map routine 400 is provided and executed by the depot control system 108.

At operation 402, the depot control system 108 receives signal strength data for a WCN 150, 152. In a non-limiting example, the signal strength data is provided by at least one of the EVSE 102 and/or a communication device of the communication module 206 provided in the area 104.

At operation 404, the depot control system 108 is configured to estimate one or more inferred signal strength at one or more regions using the obtained signal strength data. That is, the depot control system 108 estimates the signal strength at one or more regions not associated with actual signal strength data.

At operation 406, the depot control system 108 is configured to define a connectivity map using the inferred signal strength and/or the signal strength data. As provided above, the connectivity map may be realized in various suitable ways, such as a multi-dimensional layout of the area to a look-up table providing signal strength at least at the EVSE 102.

Referring to FIG. 5, an example charge operation control routine 500 is provided and executed by the depot control system 108 to manage charge operations of EVs 106.

At operation 502, the depot control system 108 determines if a charge request is received from an EV 106. This may be received via wireless communication from the EV 106.

At operation 504, if received, the depot control system 108 selects a designate EVSE 102 for performing the charge operation based on the connectivity map 214. In one form, the EVSE 102 is further selected using other information such as, but not limited to: charge port type, SOC, and/or desired pickup time.

At operation 506, the depot control system 108 transmits a message to the EV 106 to provides the location of the designated EVSE 102. In some application, the depot control system 108 also notifies the designated EVSE 102.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

In this application, the term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read only circuit), volatile memory circuits (such as a static random access memory circuit or a dynamic random access memory circuit), magnetic storage media (such as an analog or digital magnetic tape or a hard disk drive), and optical storage media (such as a USB, CD, a DVD, or a Blu-ray Disc).

The apparatuses and methods described in this application may be partially or fully implemented by a special purpose computer created by configuring a general-purpose computer (e.g., computing device) to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A system for charging one or more electric vehicles (EV) at a charge depot, comprising:
one or more communication devices configured to define a first wireless communication network (WCN) for the charge depot having a plurality of electric vehicle supply equipment (EVSE); and
one or more computing devices configured to:
define a connectivity map of an area including the plurality of EVSE using signal strength data from at least one EVSE among the plurality of EVSE, the connectivity map providing signal strength of the first WCN; and
transmit a charge instruction to an EV among the one or more EVs assigning a designated EVSE from among the plurality of EVSE at which the EV is to charge based on the signal strength at the designated EVSE provided by the connectivity map.

2. The system of claim 1, wherein the one or more communication devices are configured to communicate to one or more EVSE among the plurality of EVSE using at least one of the first WCN or a second WCN defined using a different communication protocol than the first WCN.

3. The system of claim 2, wherein the plurality of EVSE is configured to prioritize the first WCN over the second WCN in response to the signal strength of the first WCN being greater than or equal to a signal strength threshold.

4. The system of claim 2, wherein the connectivity map provides signal strength of the second WCN in the area.

5. The system of claim 1, wherein the one or more computing devices are configured to:
detect a region of the area having a signal strength less than or equal to a signal strength threshold; and
transmit a message to a selected EVSE associated with the region instructing the selected EVSE to operate as a repeater, the selected EVSE being among the plurality of EVSE.

6. The system of claim 1, wherein the one or more computing devices are configured to determine an inferred signal strength of the first WCN by the EV at one or more of the EVSE using the connectivity map, wherein the designated EVSE is further assigned based on the inferred signal strength being equal to or greater than a signal strength threshold.

7. The system of claim 1, further comprising:
a mobile signal repeater configured to boost signals of the first WCN, wherein:
the one or more computing device are configured to:
detect, using the connectivity map, a region of the area having a signal strength less than or equal to a signal strength threshold, and
provide the mobile signal repeater to the region of the area to increase the signal strength.

8. The system of claim 1, wherein the connectivity map defines signal strength at one or more regions not having the plurality of EVSE by estimating the signal strength at the one or more regions using signal strength data from the at least one EVSE among the plurality of EVSE.

9. The system of claim 1, wherein the connectivity map is defined as a heat map with a color code indicating signal strength.

10. The system of claim 1, further comprising:
a database storing historical data including signal strength data with supplemental data, the supplemental data including at least one of a time stamp of the signal strength data, weather information associated with the signal strength data, or a location of the at least one EVSE, wherein
the one or more computing devices are configured to define the connectivity map using the historical data.

11. A method for controlling charging of one or more electric vehicles (EV) at a charge depot, comprising:
generating, a first wireless communication network (WCN) for the charge depot having a plurality of electric vehicle supply equipment (EVSE);
defining a connectivity map of an area including the plurality of EVSE using signal strength data from at least one EVSE among the plurality of EVSE, the connectivity map providing signal strength of the first WCN; and
transmitting a charge instruction to an EV among the one or more EVs assigning a designated EVSE from among the plurality of EVSE at which the EV is to charge based on the signal strength at the designated EVSE provided by the connectivity map.

12. The method of claim 11, further comprising communicating, by one or more EVSE among the plurality of EVSE, using at least one of the first WCN or a second WCN defined using a different communication protocol than the first WCN.

13. The method of claim 12, further comprising selecting, by the one or more EVSE among the plurality of EVSE, the first WCN over the second WCN in response to the signal strength of the first WCN being greater than or equal to a signal strength threshold.

14. The method of claim 12, wherein the connectivity map provides signal strength of the second WCN in the area.

15. The method of claim 11, further comprising:
detecting, using the connectivity map, a region of the area having a signal strength less than or equal to a signal strength threshold; and
transmitting a message to a selected EVSE associated with the region instructing the selected EVSE to operate as a repeater, the selected EVSE being among the plurality of EVSE.

16. The method of claim 11, wherein estimating, using the connectivity map, an inferred signal strength of the first WCN by the EV at one or more of the EVSE among the plurality of EVSE using the connectivity map, wherein the designated EVSE is further assigned based on the inferred signal strength being equal to or greater than a signal strength threshold.

17. The method of claim 11, further comprising:
detecting, using the connectivity map, a region of the area having a signal strength of the first WCN less than or equal to a signal strength threshold; and
providing a mobile signal repeater at the region of the area to increase the signal strength of the first WCN.

18. The method of claim 11, wherein the connectivity map defines signal strength at one or more regions not having the plurality of EVSE by estimating the signal strength at the one or more regions using signal strength data from the at least one EVSE among the plurality of EVSE.

19. The method of claim 11, wherein the connectivity map is defined as a heat map with a color code indicating signal strength.

20. The method of claim 11, further comprising:
storing historical data including the signal strength data with supplemental data, the supplemental data including at least one of time stamp, weather information associated with the signal strength data, or location of the at least one EVSE; and
defining the connectivity map using the historical data.
